(19) United States
(12) Patent Application Publication
(10) Pub. No.: US 2011/0000348 A1
(43) Pub. Date: Jan. 6, 2011

(54) Control and management method for lathes and loaders for lathes and apparatus for performing the method

(76) Inventors: Pierantonio Melandri, Faenza (IT); Andrea Bassi, Faenza (IT); Claudio Magnani, Mezzano (IT); Andrea Ghinassi, Faenza (IT); Francesco Turchetti, Faenza (IT); Luca Reali, Faenza (IT); Mauro Mirandola, Riolo Terme (IT); Filippo Bandini, Faenza (IT); Maurizio Moretti, Fognano-Brisighella (IT); Vittorio Pestillo, Faenza (IT)

Correspondence Address: Modiano & Associati, Via Meravigli 16, Milano, 20123, IT

(21) Appl. No.: 12/736,070

(22) PCT Filed: Mar. 7, 2008
(86) PCT No.: PCT/IT2008/000150

§ 371 Date: Sep. 7, 2010

(51) Int. Cl. B23B 9/00

(52) U.S. Cl. 82/118

(57) ABSTRACT

A control and management method for lathes and loaders for lathes, comprising the steps of:
detecting geometric parameters and mechanical characteristics of a bar to be turned;
determining development of the critical frequencies of the bar upon a rotation thereof about the longitudinal axis as the rotation rate and length of the bar vary;
starting turning of the bar, avoiding the combinations of mandrel rotation rate and bar length at which the rotation rate of the bar intersects the curves that represent the development of the critical frequencies.

The present invention relates to a control and management method for lathes and loaders for lathes and to an apparatus for performing the method.

### BACKGROUND OF THE INVENTION

The lathe is a machine tool for machining a part which is turned with respect to a tool.

The lathe used to machine metals has a machining motion constituted by the rotation of the part being machined with respect to the tool, which is mounted on a turret tool post and slides parallel to the axis of rotation.

The part can be mounted in a cantilever fashion on a self-centering mandrel which protrudes from the driving head, or can be supported between the mandrel and the tailstock, which is axially aligned in front of the mandrel at an adjustable distance.

The parallel advancement motion of the turret tool post can be manual or automatic, depending on the rotary motion of the tool.

For large-scale machinings, a loader is usually associated with the lathe and is intended to feed the lathe continuously and in a controlled manner.

In practice, the loader provides bars to the lathe: depending on the architecture of the lathe (single- or multi-mandrel), the loader will be shaped appropriately in order to guide the bars correctly to the appropriate mandrel of said lathe.

The system constituted by the lathe and the loader has the advantage of being substantially autonomous for long operating times (which depend on the speed of the machining processes performed by the lathe and on the capacity of the bar magazine in the loader).

Obviously, if the bar is guided toward the mandrel and inside the mandrel in an optimum manner, the vibrations to which the entire system is subjected are low (the bar does not warp) and machinings can be more precise.

The bars are directed toward the mandrel through a guide which is provided at the rear with a bar pusher, on which the rear portion of said bar is clamped.

The diameter of the bar pusher can be larger than the diameter of the bar, since it comprises the collet that retains the rear end of the bar. The bar pusher must be able to pass through the guide (whose diameter must be at least slightly larger than the maximum diameter of the bar pusher) until it passes through the mandrel and substantially faces the end part of said mandrel (part clamping region). The bar, therefore, can oscillate and flex within the guide (as a consequence of the rotation to which it is subjected). The vibrations generated by these movements can compromise some machining operations (or in any case make them particularly complex).

All the solutions provided for loaders and lathes are not suitable to avoid completely the triggering of vibrational phenomena which, being characterized by possible resonances, entail damage to the product being machined and, in certain particularly severe cases, also of the components of the loader and the lathe.

The only possibility, if substantial vibrational phenomena of the bars are triggered, is to stop the machines as soon as possible or reduce significantly the rotation rate of the bars. Of course, this solution severely compromises or reduces the productivity of the apparatus.

### SUMMARY OF THE INVENTION

The aim of the present invention is to provide a control and management method for lathes and loaders for lathes which is adapted to avoid the triggering of vibrational phenomena.

Within this aim, an object of the present invention is to provide an apparatus for performing the method, suitable for automatic control of the lathe and/or of the loader to prevent the triggering of vibrational phenomena.

Another object of the present invention is to provide a control and management method for lathes and lathe loaders and an apparatus for performing the method which have low costs, are relatively simple to provide in practice and safe in application.

This aim and these and other objects, which will become better apparent hereinafter, are achieved by the present control and management method for lathes and loaders for lathes, comprising the steps of:

detecting the geometric parameters and the mechanical characteristics of a bar to be turned;

determining the development of the critical frequencies of said bar upon a rotation thereof about the longitudinal axis as the constraints and length of said bar vary;

starting the turning of said bar, avoiding the combinations of mandrel rotation rate and bar length at which the rotation rate of said bar intersects the curves that represent the development of the critical frequencies.

This aim and these objects are also achieved by means of the apparatus for performing the method of claim 1, characterized in that it comprises an interface for entering the geometric and mechanical parameters of each individual bar, a device for continuously detecting the length of each individual bar, a computer, which is controlled by said interface and said device and is intended to calculate the critical frequencies of each individual bar as a function of the length of said bar and of its rotation rate, and a control unit which is associated with at least one machine, between said lathe and said loader, adapted to modify the operating conditions of the at least one machine.

### BRIEF DESCRIPTION OF THE DRAWINGS

Further characteristics and advantages of the invention will become better apparent from the following detailed description of a preferred but not exclusive embodiment of a control and management method for lathes and loaders for lathes and of an apparatus for performing the method, illustrated by way of non-limiting example in the accompanying drawings, wherein:

FIG. 1 is a block diagram of a control and management method for lathes and loaders for a lathes according to the invention;

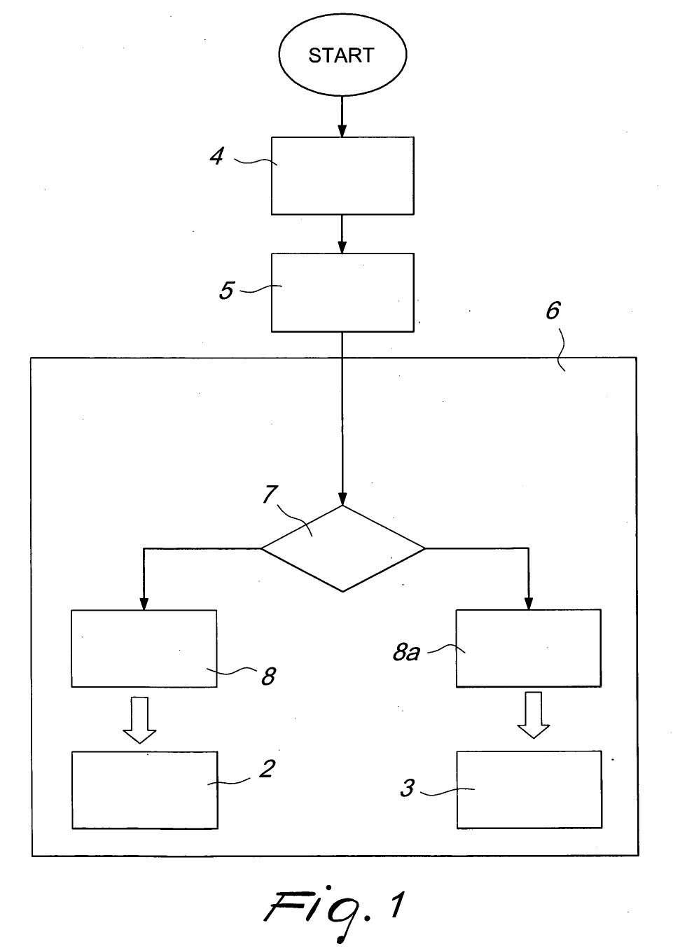

FIG. 2 is a chart which plots the curves that correspond to the critical resonance frequencies of a bar, which are adopted in the control and management method for lathes and loaders for lathes according to the invention;

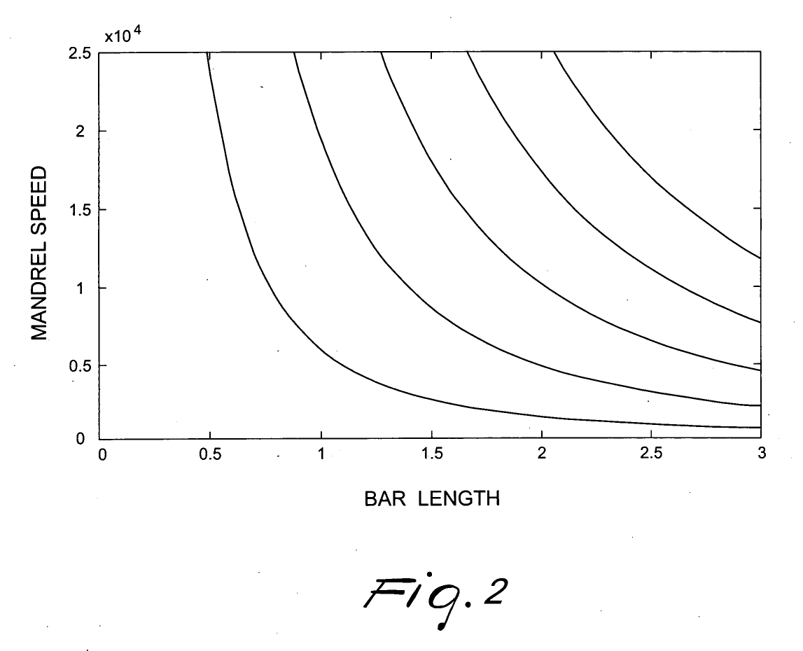

FIG. 3 is a chart which plots the curves that correspond to the critical resonance frequencies of a bar, which are adopted in the control and management method for lathes and loaders for lathes according to the invention, on which the development of the rotation rate of the mandrel of the lathe, as a consequence of the correction imposed by said method, is plotted;

FIG. 4 is a block diagram of a possible apparatus which applies the control and management method for lathes and loaders for lathes according to the invention.

### DESCRIPTION OF THE PREFERRED EMBODIMENTS

With reference to the figures, a control and management method for lathes 2 and loaders for lathes 3 will be described.

Such method provides a first step 4 for detecting the geometric parameters and mechanical characteristics of a bar to be turned. The bars generally have a constant development; therefore, once the shape of the cross-section (which is generally circular but in certain cases is also polygonal), the diameter (in the case of a polygonal cross-section, the maximum diameter, the minimum diameter and the length of the sides) and the overall length have been detected, it will be sufficient to input the mechanical characteristics of the material that constitutes the bar (for example modulus of elasticity, stiffness, etcetera) to define unambiguously all the parameters of a bar that can affect its behavior during the turning operations. Such measurements might also be performed by an operator before the bars enter the loader 3 or optionally the loader 3 itself might comprise sensors intended to detect all this information.

The second step 5 of the method provides for determining the development of the critical frequencies of the bar upon a rotation about its own longitudinal axis: this development must be determined as the rotation rate and the length of the bar vary; during machining, the bar in fact undergoes length variations which of course affect the above mentioned developments.

For example, in order to calculate the critical rotation rates (which correspond to the critical resonance frequencies), each individual bar is interpreted as being constituted by a plurality of discrete elements; the dynamic behavior of each one of these elements can be interpreted by means of a respective equation. These equations can be solved in a group by means of a system of equations by applying the finite element method (FEM). The simplification that can be adopted in order to determine the critical frequencies of the bars with sufficient approximation is to discretize each bar by means of one-dimensional elements.

Two contiguous bar elements are mutually connected by means of a structural node. For each node, it is possible to lock the movement or the rotation so as to simulate the most common constraints. It is further possible to introduce a constraint of the elastic type for each node which limits its mobility, recreating a model which replicates as fully as possible the actual behavior.

Once the constraint parameters have been defined, one proceeds with calculating the characteristics of mass, stiffness and damping of the individual elements.

A simplified version of the mass and stiffness matrices of the elements is the following:

$$\begin{matrix}{[ M ]}_{elem} = [ \begin{matrix}\frac{m}{2} & 0 \\ 0 & \frac{m}{2}\end{matrix} ] & \\ {[ K ]}_{elem} = \frac{EJ}{{L}^{3}} [ \begin{matrix}12 & 6 L & - 12 & 6 L \\ 6 L & 4 {L}^{2} & - 6 L & 2 {L}^{2} \\ - 12 & - 6 L & 12 & - 6 L \\ 6 L & 2 {L}^{2} & - 6 L & 4 {L}^{2}\end{matrix} ] & \end{matrix}$$

As regards damping, instead, one considers the internal damping effect of the material and the gyroscopic effect on the bar. The latter has a stabilizing action and depends greatly on the rotation rate.

All the matrices of the individual elements are assembled and the total mass, damping and stiffness matrices of the system are calculated.

$$[ M ] = [ \begin{matrix}{[ M ]}_{1} & … & 0 \\ ⋮ & ⋱ & ⋮ \\ 0 & ⋯ & {[ M ]}_{n}\end{matrix} ] \\ [ C ] = [ \begin{matrix}{[ C ]}_{1} & … & 0 \\ ⋮ & ⋱ & ⋮ \\ 0 & ⋯ & {[ K ]}_{n}\end{matrix} ] \\ [ K ] = [ \begin{matrix}{[ K ]}_{1} & … & 0 \\ ⋮ & ⋱ & ⋮ \\ 0 & ⋯ & {[ K ]}_{n}\end{matrix} ]$$

The constraints are introduced in the system and the following complex eigenvalue problem is solved:

[M]\ddot{x}+[C]\dot{x}+[K]x=0

obtaining as results the critical rotation rates and the vibration modes of the system thus constrained.

At this point, step 6 provides for starting the turning of the bar, avoiding the combinations of mandrel rotation rate and bar length at which the rotation rate of said bar intersects the curves that represent the development of the critical frequencies.

The end part of step 6 that provides for the possibility to avoid the intersection of the rotation rate of the lathe 2 with the critical frequencies of the bar can be performed by acting on the lathe 2 or on the loader 3 or optionally on both: it is therefore necessary to make a choice 7.

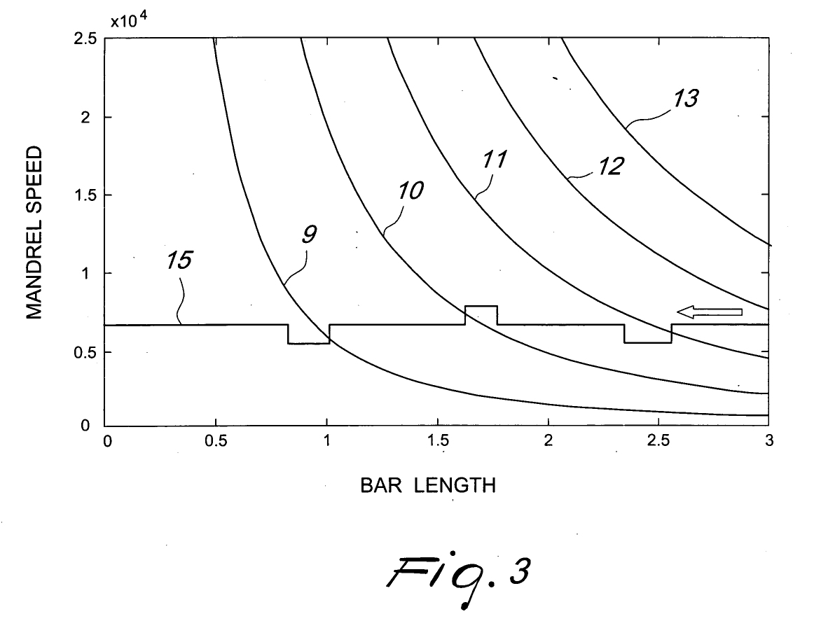

The turning step 6, performed avoiding the combinations of mandrel rotation rate and bar length at which the rotation rate of the bar intersects the curves that represent the development of the critical frequencies, can consist in modifying the rotation rate 8 of the bar in the neighborhood of any possible intersection between a critical frequency development curve and the standard rotation rate of the bar imposed by the lathe 2. This operating possibility is shown in FIG. 3, where the lines 9, 10, 11, 12 and 13 represent respectively the developments of the first, second, third, fourth and fifth critical frequencies of the bar and the line 15 represents the development of the rotation rate of the lathe 2 adapted to avoid the dangerous intersections. The chart plots on the abscissas the length of the bar and on the ordinates the rotation rate of the mandrel of the lathe 2.

As can be seen in FIG. 3, a sudden reduction in the rotation rate of the mandrel of the lathe 2 ensures avoiding the intersection with the developments of the critical frequencies. When this intersection value is exceeded, the speed is again returned to the standard value to ensure that the lathe 2 works in accordance with the maximum efficiency conditions.

The modification of the rotation rate 8 of the bar in the neighborhood of every possible intersection between a critical frequency development curve 9, 10, 11, 12 and 13 and the standard rotation rate of the bar imparted by the lathe 2 therefore consists in reducing suddenly the rotation rate of the bar ahead of the possible intersection and returning it to the standard value downstream of said intersection.

As an alternative, the modification of the rotation rate 8 of the bar in the vicinity of any possible intersection between a critical frequency development curve and the standard rotation rate of the bar imposed by the lathe 2 can consist in suddenly increasing the rotation rate of the bar, ahead of the possible intersection, and returning it to the standard value thereafter.

The choice of one possibility or of the other depends directly on the operating requirements of the lathe 2 and of the bars being machined.

As an alternative, the turning step 6 performed avoiding the combinations of mandrel rotation rate and bar length at which the rotation rate of said bar intersects the curves that plot the development of the critical frequencies, consists in arranging 8a at least one removable constraint on respective portions of the bar, an operation generally performed within the bar guide that is present in the loader 3.

According to an embodiment of particular interest in practice and in application, the removable constraint is a rotating bush, which is adapted to surround the bar, rotating rigidly therewith, and is able to perform a translational motion along a direction which is substantially parallel to the axis of the bar.

As an alternative, it would be possible in any case to provide the removable constraint by means of fixed apparatuses of the friction type (such as fixed guides) or with any other element which blocks the translational motions of the bar along the axes at right angles to the rotation axis (longitudinal).

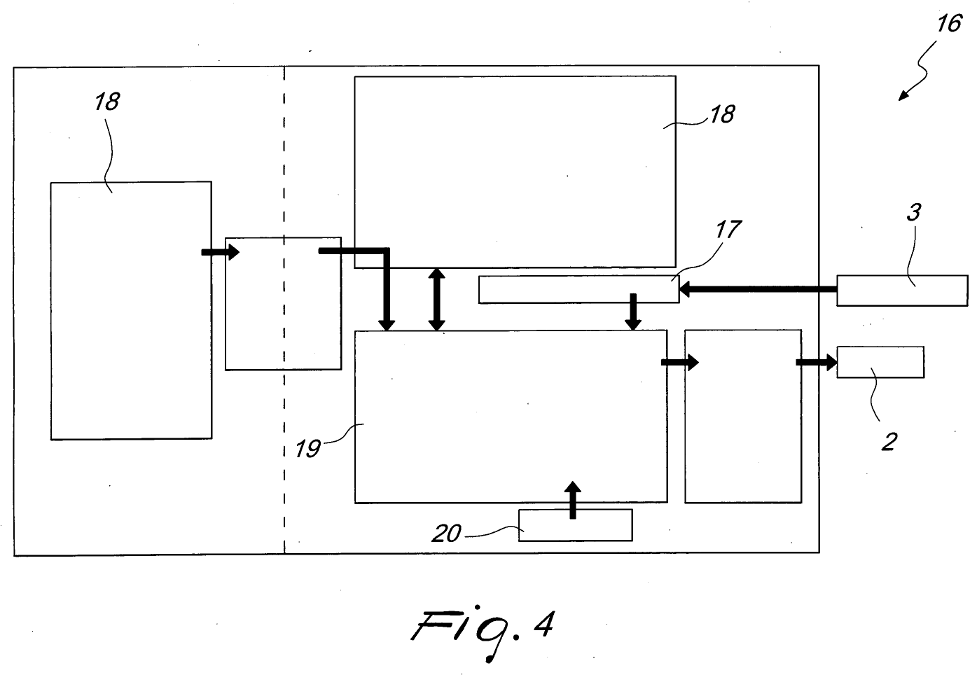

The apparatus 16 for performing the method is shown schematically in FIG. 4, and comprises an interface for introducing the geometric and mechanical parameters of each individual bar (in particular, it can be a computer 18, or personal computer, in which the operator can input the bar parameters, or it is possible to provide an element for detecting such parameters automatically), a device 17 for continuous detection of the length of each individual bar (arranged within the loader 3), the computer 18, controlled by the device 17, intended to calculate the critical frequencies of each individual bar as a function of the length of said bar and of its rotation rate, and an actuation unit 19, which is associated with at least one machine, between the lathe 2 and the loader 3, which is suitable to modify the operating conditions of the at least one machine.

It should be noted that, according to a constructive embodiment of particular interest in practice and in application, the control unit 19 is functionally associated with the assembly for moving the mandrel of the lathe 2 to adjust the rotation rate of the bar according to a rule of motion imposed by the computer 18, the development of which does not intersect the developments 9, 10, 11, 12 and 13 of the critical frequencies calculated by the computer 18.

A particularly efficient constructive architecture provides that the control unit 19 is functionally associated with the guiding seat for the bar of the loader 3, in order to position removable constraints constituted by respective rotating bushes, which are adapted to surround the bar, rotating jointly connected thereto, in a direction which is substantially parallel to the axis of the bar, producing a translation of the developments 9, 10, 11, 12 and 13 of the critical frequencies and therefore avoiding the intersection thereof with the rule of motion of the bar imposed by the lathe 2.

The apparatus 16 according to the invention may further comprise at least one accelerometer 20, which is functionally associated with the bar and is adapted to determine vibrations thereof.

In this case, the accelerometer 20 is controlled by the computer 18 and by the actuation unit 19 to detect and store vibration frequencies which cannot be calculated on the basis of the geometric and mechanical parameters of each individual bar and to modify the operating conditions of the at least one machine, between the lathe 2 and the loader 3, in order to stop the detected vibrations.

In practice, the accelerometer 20 allows to perform a feedback on the operation of the lathe 2 and of the loader 3 which depends on the onset of vibrations at operating frequencies which do not correspond to the critical resonance frequencies. These phenomena can occur because a given bar can have a certain irregularity in its shape which entails a deviation of its behavior with respect to the condition calculated on the basis of ideal shapes or a nonuniformity of the mechanical properties which entails similar deviations.

Even vibrational behaviors which are not predictable with preventive calculation can be damped, therefore, by means of the apparatus 16 according to the invention.

The method and the apparatus 16 according to the invention therefore allow to obtain maximum efficiency from the industrial system constituted by the lathe 2 and the loader 3 and reduce enormously the production waste, since all the operating conditions that can trigger dangerous vibrational phenomena, which are often subject to resonance, are avoided.

It has thus been shown that the invention achieves the proposed aim and objects.

The invention thus conceived is susceptible of numerous modifications and variations, all of which are within the scope of the appended claims.

All the details may further be replaced with other technically equivalent ones.

In the exemplary embodiments that follow, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the shapes and dimensions, may be any according to requirements without thereby abandoning the scope of the protection of the appended claims.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-11. (canceled)

12. A control and management method for lathes and loaders for lathes, comprising the steps of:
detecting geometric parameters and mechanical characteristics of a bar to be turned;
determining development of the critical frequencies of said bar upon a rotation thereof about the longitudinal axis as the constraints and length of said bar vary;
starting turning of said bar, avoiding combinations of mandrel rotation rate and bar length at which the rotation rate of said bar intersects the curves that represent the development of the critical frequencies.

13. The method according to claim 12, wherein the turning step, performed avoiding the combinations of rotation rate of the mandrel and bar length at which the rotation rate of said mandrel intersects the curves that represent the development of the critical frequencies, consists in modifying the rotation rate of said bar in the neighborhood of every possible intersection between a critical frequency development curve and the standard rotation rate of the bar imposed by the mandrel of the lathe.

14. The method according to claim 13, wherein the modification of the rotation rate of the bar in the neighborhood of every possible intersection between a curve of the development of the critical frequency and the standard rotation rate of the bar imposed by the lathe consists in reducing suddenly the rotation rate of the bar ahead of the possible intersection and returning it to the standard value downstream of said intersection, according to a development.

15. The method according to claim 13, wherein the modification of the rotation rate of the bar in the neighborhood of every possible intersection between a critical frequency development curve and the standard rotation rate of the bar imposed by the lathe consists in increasing suddenly the rotation rate of the bar ahead of the possible intersection and returning it to the standard value downstream of said intersection.

16. The method according to claim 12, wherein the turning step performed avoiding the combinations of mandrel rotation rate and bar length at which the rotation rate of said bar intersects the curves that represent the development of the critical frequencies, consists in arranging at least one removable constraint on respective portions of said bar which are comprised equally in the lathe and in the loader.

17. The method according to claim 16, wherein each of said removable constraints is adapted to surround said bar with appropriate degrees of freedom in order to rotate rigidly therewith and perform a translational motion along a direction which is substantially parallel to the axis of said bar, modifying, by means of said translational motion, the arrangement/position of said critical frequencies.

18. An apparatus for performing the method of claim 12, comprising an interface for entering geometric and mechanical parameters of each individual bar, a device for detecting continuously a length of each individual bar, a computer, which is controlled by said interface and said device and which is intended to calculate critical frequencies of each individual bar as a function of the length of said bar and of a rotation rate thereof, and a control unit which is associated with at least one machine, between said lathe and said loader, which is adapted to modify operating conditions of the at least one said machine.

19. The apparatus according to claim 18, wherein said control unit is functionally associated with the assembly for moving the mandrel of said lathe to adjust the rotation rate of the bar according to a rule of motion which is imparted by said computer, the development of which does not intersect the developments of the critical frequencies calculated by said computer.

20. The apparatus according to claim 18, wherein said control unit is functionally associated with the guiding seat for the bar of said loader, in order to position removable constraints, which are constituted for example by respective rotating bushes which are adapted to surround said bar, rotating rigidly therewith, along a direction which is substantially parallel to the axis of said bar, producing a translation of the developments of the critical frequencies and therefore avoiding their intersection with the rule of motion of the bar imposed by the lathe.

21. The apparatus according to claim 18, further comprising at least one accelerometer which is functionally associated with said bar and is adapted to determine vibrations of said bar.

22. The apparatus according to claim 21, wherein said accelerometer is controlled by said computer and said control unit for the detection, storage and management of the vibration frequencies which cannot be calculated on the basis of the geometric and mechanical parameters of each individual bar, and for the modification of the operating conditions of the at least one machine, between said lathe and said loader, in order to stop the detected vibrations.
